(19) United States
(12) Patent Application Publication
(10) Pub. No.: US 2022/0364402 A1
(43) Pub. Date: Nov. 17, 2022

(54) LOCKING HINGE

(71) Applicant: NATHAN CARDWELL, NORMAN, OK (US)

(72) Inventor: NATHAN CARDWELL, NORMAN, OK (US)

(21) Appl. No.: 17/321,790

(22) Filed: May 17, 2021

(51) Int. Cl. E05D 11/10; E05D 3/02

(52) U.S. Cl. CPC E05D 11/1007; E05D 3/02; E05D 11/1014; E05Y 2900/132; E05Y 2201/218

(57) ABSTRACT

The current invention relates to the field of hinges, more specifically locking hinges. It is often desirable to automatically secure a door at a position, for example while loading or unloading a vehicle, but most hinges on the market are unable to secure the door automatically. The current invention solves this problem by incorporating a securing means within the barrel of the hinge itself that is capable of releasably securing an attached door along the axis of rotation. The principal use of the preferred embodiment is on a travel trailer, the hinge serving to secure an entry door while loading or unloading the trailer.

### CROSS-REFERENCE TO RELATED APPLICATIONS

None.

### FIELD OF THE INVENTION

The invention relates generally to hinges, and more specifically to locking door hinges.

### BACKGROUND OF THE RELATED ART

Hinges permit ingress and egress into buildings and vehicles. In many situations it is desirable to secure a hinge and attached door open automatically, for example while unloading a vehicle. Therefore, what is needed is a hinge that permits both ingress and egress, and which automatically and releasably secures the door.

Many attempts have been made to provide a locking hinge. The first family of locking hinges are those which incorporate the locking means into the hinge pivot. An example of this type of hinge is U.S. Pat. No. 8,359,709 to Van Gennep. This style of hinge relies on the pivot itself to releasably secure the hinge and attached structures.

A second type of locking hinge utilizes a two-part solution to keep the hinge in the desired position. An example of this type of hinge is U.S. Pat. No. 8,584,318 to Tu, which discloses a hybrid mechanism wherein the pivot incorporates a notch which mates with a corresponding indentation on the barrel, the pivot notch and barrel indentation working in tandem to releasably secure the hinge in the desired position.

The above-mentioned attempts to solve the problem of automatically securing a hinge are unsatisfactory and introduce unnecessary complexity. What is needed, then, is a device that acts as similarly as possible to a normal hinge and releasably locks at a certain position.

### SUMMARY OF THE INVENTION

The current invention solves this problem by utilizing the hinge barrel itself to secure the hinge in the desired position by incorporating at least one indentation and one protrusion fixed within the barrel wall. The indentation and protrusion are capable of engaging one another to automatically secure a hinge. This arrangement allows the user to employ generic hinge parts, except for the modified barrel, simplifying the overall design while providing higher reliability.

### BRIEF DESCRIPTION OF THE DRAWINGS

FIG. 1 is a front view of the current invention.

FIG. 2 is a front perspective view of the current invention in a second position.

FIG. 3a is a front view of a first portion of the current invention without a pivot.

FIG. 3b is a front view of a second portion of the current invention without a pivot.

FIG. 4 is a front view of an alternative embodiment of the current invention without a pivot.

FIG. 5 is a front view of an alternative embodiment of the current invention with a pivot.

FIG. 6. is a front perspective view of the current invention without a pivot.

### DESCRIPTION OF THE PREFERRED EMBODIMENTS

The preferred embodiment of the current invention utilizes an adjustable barrel-located means for releasably securing a hinge in the desired position. The barrels of the current invention are concentric and share the same inside diameter. The securing means for each barrel is located such that when the hinge is actuated to a second position, the first barrel securing means and the second barrel securing means releasably engage to secure the door in a second position. In the preferred embodiment, the barrel securing means take the form of an indentation and corresponding protrusion, both of which form part of the barrel.

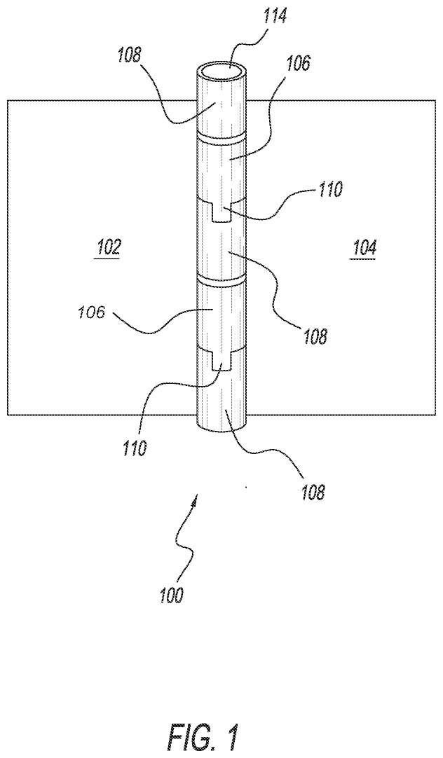

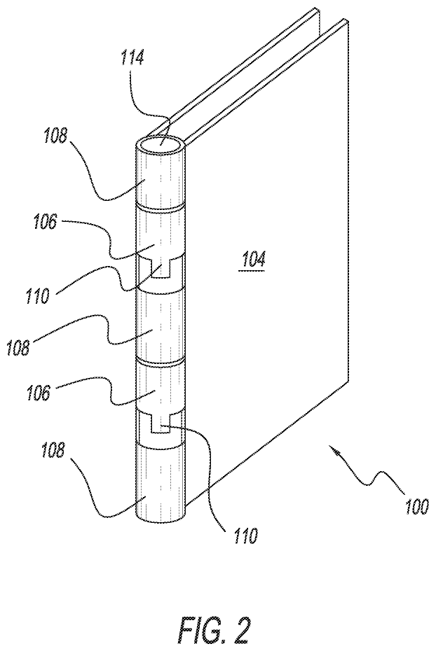

FIGS. 1 and 2 show front views of an embodiment of the hinge assembly 100 in a first and second position. Once the user actuates the hinge assembly 100 to a second position, the protrusion 110 and corresponding indentation 112 engage, securing the hinge assembly 100 in a second position. The first portion barrels 106 glide above the second portion barrels 108, permitting free rotation of the hinge assembly 100 about the pivot 114. To disengage the locked hinge assembly 100, the user must lift the door, retracting the protrusion 110 from the indentation 112, thereby permitting the hinge assembly 100 to once again rotate about the pivot 114.

In this embodiment, the user has opted to automatically secure the hinge assembly 100 once it reaches an angle of one-hundred-and-eighty degrees, but the current invention can be adapted to secure the hinge assembly 100 at nearly any angle along the circumference of the first portion barrel 106 or second portion barrel 108. Also, these embodiments show a protrusion 110 on a first portion 102 and an indentation 112 on a second portion 104. This arrangement is not required, but instead the indentation 112 and protrusion 110 may be mounted on any portion which permits them to engage.

The indentation 112 and protrusion 110 in the preferred embodiment are rectangular in shape, having a height of 4 millimeters and a width of 5 millimeters. The indentation 112 and protrusion 110 are not limited to a rectangular shape, and may comprise any shape or design which permits the barrel portions to releasably engage.

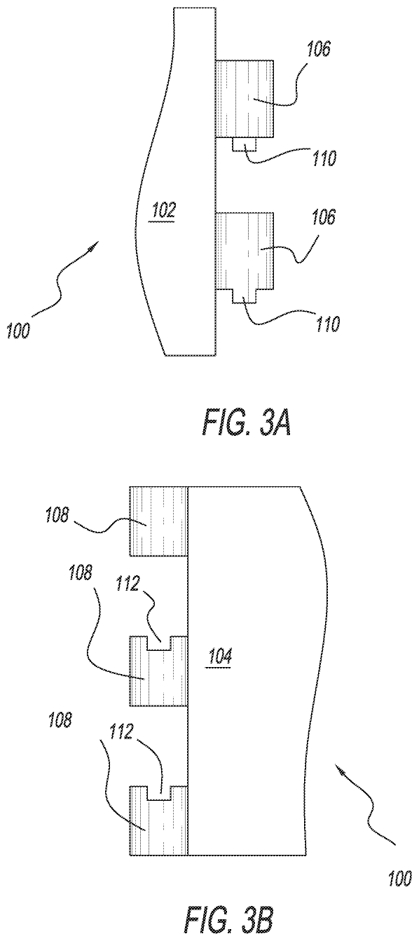

FIGS. 3a and 3b show the two halves of the current invention, in order to more clearly show the protrusions 110 and indentations 112. FIG. 2a shows the first portion barrel 106 protrusions 110. FIG. 2b shows the second portion barrel 108 and corresponding indentations 112. The shape and arrangement of the protrusions 110 and indentations 112 vary according to usage conditions. In this figure, the user has opted for two indentations 112, located on opposite sides of the second portion barrel 108. This arrangement permits the hinge to lock at two different points along the axis of rotation.

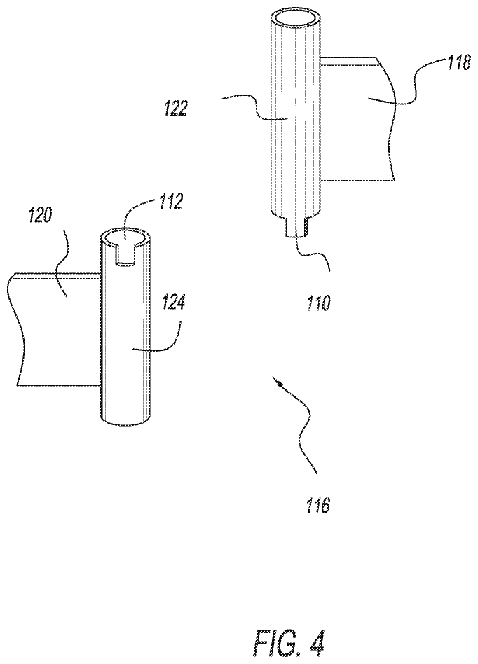

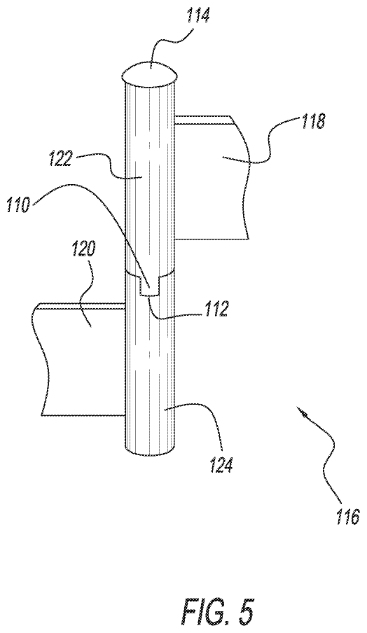

FIG. 4 shows an alternative embodiment 116 of the current invention wherein the barrel portions have been reduced to a single first portion barrel 122 and a single second portion barrel 124. This embodiment also features a single indentation 112 and protrusion 110. FIG. 5 shows the alternative embodiment 116 with a pivot 114 inserted through the first portion barrel 122 and second portion barrel 124. This alternative embodiment 116 excels in applications where the weight of the structure attached to the hinge assembly 100 is lighter, for example a recreational-vehicle door or window.

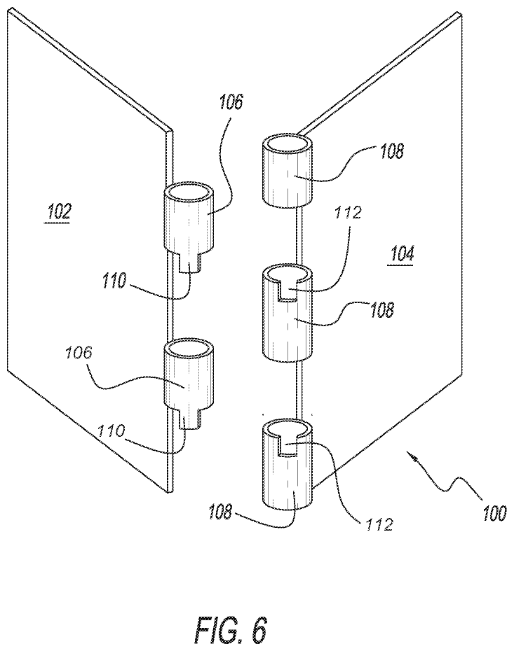

FIG. 6 shows the current invention without a pivot in order to better show the arrangement of the indentations 112 and protrusions 110. To attach the hinge halves to one another, the user simply must align the barrels indentations 112 and protrusions 110. This figure also shows the locations of the indentations 112 and protrusions 110 within the wall portion of the first portion barrel 106 or the second portion barrel 108.

I claim:

1. A hinge assembly comprising:
At least one first portion barrel having a wall portion, a first opening, and a second opening, said first opening and second opening defining a space therein, said wall portion further comprising an indentation;
At least one second portion barrel having a wall portion, a first opening, and a second opening, said first opening and second opening defining a space therein, said wall portion further comprising a protrusion;
a pivot passing through the first portion barrel and the second portion barrel and releasably securing the first portion barrel and the second portion barrel; said pivot permitting rotation of the hinge assembly;
wherein actuation of the hinge assembly about the pivot from a first position to a second position releasably engages the first portion barrel indentation and the second portion barrel protrusion, securing the hinge in the second position.

2. The invention of claim 1 wherein the first portion barrel indentation and the second portion barrel protrusion further comprise a rectangular shape.

3. The invention of claim 1 wherein the first portion barrel and the second portion barrel further comprise a cylindrical shape.

4. The invention of claim 1 wherein the first portion barrel further comprises a plurality of protrusions.

5. The invention of claim 1 wherein the second portion barrel further comprises a plurality of indentations.

6. The invention of claim 1 wherein the first portion barrel and the second portion barrel are concentric and have the same inside diameter.

7. A hinge assembly comprising:
At least one first portion barrel having a wall portion, a leaf portion, a first opening, and a second opening, said first opening and second opening defining a space therein, said wall portion further comprising an indentation;
At least one second portion barrel having a wall portion, a leaf portion, a first opening, and a second opening, said first opening and second opening defining a space therein, said wall portion further comprising a protrusion;
a pivot passing through the first portion barrel and the second portion barrel and releasably securing the first portion barrel and the second portion barrel; said pivot permitting rotation of the hinge assembly;
wherein actuation of the hinge assembly about the pivot from a first position to a second position releasably engages the first portion barrel indentation and the second portion barrel protrusion, securing the hinge in the second position.

8. The invention of claim 7 wherein the first portion barrel indentation and the second portion barrel protrusion comprise a rectangular shape.

9. The invention of claim 7 wherein the first portion barrel and the second portion barrel comprise a cylindrical shape.

10. The invention of claim 7 wherein the first portion barrel further comprises a plurality of protrusions.

11. The invention of claim 7 wherein the second portion barrel further comprises a plurality of indentations.

12. The invention of claim 7 wherein the first portion barrel and the second portion barrel are concentric and have the same inside diameter.

13. A hinge assembly comprising:
A plurality of first portion barrels each having a wall portion, a leaf portion, a first opening, and a second opening, said first opening and second opening defining a space therein, said wall portion further comprising an indentation;
A plurality of second portion barrels each having a wall portion, a leaf portion, a first opening, and a second opening, said first opening and second opening defining a space therein, said wall portion further comprising a protrusion;
a pivot passing through the first portion barrel and the second portion barrel and releasably securing the first portion barrel and the second portion barrel; said pivot permitting rotation of the hinge assembly;
wherein actuation of the hinge assembly about the pivot from a first position to a second position releasably engages the first portion barrel indentation and the second portion barrel protrusion, securing the hinge in the second position.

14. The invention of claim 13 wherein the first portion barrel indentation and the second portion barrel protrusion comprise a rectangular shape.

15. The invention of claim 13 wherein the first portion barrel and the second portion barrel comprise a cylindrical shape.

16. The invention of claim 13 wherein the first portion barrel further comprises a plurality of protrusions.

17. The invention of claim 13 wherein the second portion barrel further comprises a plurality of indentations.

18. The invention of claim 13 wherein the first portion barrel and the second portion barrel are concentric and have the same inside diameter.

19. The invention of claim 13 wherein the indentation of the wall portion of the first portion barrel is at least 0.1 times a circumference of said first portion barrel.

20. The invention of claim 13 wherein the protrusion of the wall portion of the second portion barrel is at least 0.1 times a circumference of said second portion barrel.
